(19) United States
(12) Patent Application Publication
(10) Pub. No.: US 2023/0278804 A1
(43) Pub. Date: Sep. 7, 2023

(54) CONVEYOR SYSTEM FOR THE LOCAL TRANSPORT OF WORKPIECES AND USE OF SAME WITH OR IN A COATING SYSTEM

(71) Applicant: Rippert Besitzgesellschaft Mbh & Co. KG, Herzebrock-Clarholz (DE)

(72) Inventors: Rainer Starz, Weil der Stadt (DE); Matthias Krey, Freiberg am Neckar (DE)

(73) Assignee: Rippert Besitzgesellschaft Mbh & Co. KG, Herzebrock-Clarholz (DE)

(21) Appl. No.: 17/999,432

(22) PCT Filed: May 17, 2021
(86) PCT No.: PCT/EP2021/062958

§ 371 Date: Nov. 21, 2022

(30) Foreign Application Priority Data
May 26, 2020 (DE) 10 2020 114 047.9

(51) Int. Cl. B65G 17/12; B05B 13/02; B05B 16/00

(52) U.S. Cl. CPC B65G 17/12; B05B 13/0221; B05B 16/95; B65G 2201/02

(57) ABSTRACT

A conveyor system for the local transport of workpieces having a track having rail sections extending next to one another, with portions, inclined differently from one another relative to a horizontal plane, along which load carriers for receiving the workpieces, are movable one behind the other. Each load carrier has a running gear with a first and a second bearing assembly spaced apart from each other relative to the extension of the track and by which the load carriers are guided on the track. In some sections, the relative height positions of two rails section running next to one another are different from one another. The load carriers, which are each guided via their first bearing assembly on one rail section and via their second bearing assembly on one further rail section, are, relative to the direction of travel, horizontally oriented the same at every point of the track.

### CROSS REFERENCE TO RELATED APPLICATIONS

This application is the US national phase of and claims the benefit of and priority on International Application No. PCT/EP2021/062958 having an international filing date of 17 May 2021, which claims priority on and the benefit of German Patent Application No. 10 2020 114 047.9 having a filing date of 26 May 2020.

### BACKGROUND OF THE INVENTION

### Technical Field

The invention relates to a conveyor system, in particular a circulating conveyor system, for the local transport of workpieces, comprising a track having rail sections extending next to one another, with portions which are inclined differently from one another in relation to a horizontal plane and along which load carriers designed to receive the workpieces are movable one behind the other, wherein each load carrier has a running gear with at least one first bearing assembly and at least one second bearing assembly, which is spaced apart from the first bearing assembly in relation to the extension of the track and through which the load carriers are guided on the track. Furthermore, the invention relates to use of this conveyor system with or in a coating system, wherein at least one section of the track of the conveyor system extends through the coating system and the workpieces to be transported through the coating system take the form of motor vehicle rims, in particular car rims, or comprise at least parts thereof.

### Prior Art

Conveyor systems of the type in question here are used for the mostly locally limited transport of workpieces that are to be machined or finished. Within industrial production and/or processing facilities, they ensure the necessary material flow. Systems operated in particular in the sense of a circuit enable successive loading with workpieces and subsequent removal, which can take place over limited periods of time up to virtually continuous operation. The workpieces transferred to the conveyor system can thus be fed to at least one processing operation, such as the surface treatment in a coating system. In this way, two or more processing operations that are spatially separated from one another and in this respect are to be passed through one after the other can also be concatenated.

Such conveyor systems can be designed, for example, as manual overhead conveyors, circulating conveyor systems or so-called power-and-free systems, to name only a few possible embodiments. The latter embodiment permits detachment from the conveyor circuit in order to enable, for example, a moving part of the conveyor system to be retained or transferred together with the workpiece to another conveyor path or circuit. As a result of this possibility of transfer, workpieces can sometimes travel complex paths, which then not only run in the horizontal plane but, alternatively or simultaneously, also in the vertical direction thereto. In addition to the mostly suspended arrangement of workpieces beneath a conveyor system, their placement on such a conveyor is also known, such as in the case of a spindle conveyor.

Currently, in power-and-free systems, there is already a vertical conveyor option in which the conveyed material, including the item holder, remains in a horizontal state, despite an incline. However, this means a very complicated design since each individual carriage requires an adjustment mechanism. This is expensive, complicated and sensitive, especially to contamination.

DE 10 2011 100 825 A1 discloses a conveyor system which, in the embodiment as a spindle conveyor, serves for the stationary transport of workpieces, in particular of vehicle wheels. The conveyor system comprises a track with rail sections extending next to one another. Here, the track has individual portions which are inclined differently from one another in relation to a horizontal plane. Load carriers which are movable one behind the other along the track are designed to each receive at least one workpiece. Each of these load carriers has a running gear which has at least one first bearing assembly and at least one second bearing assembly, wherein the two bearing assemblies are spaced apart from one another in relation to the extension of the track. By means of the bearing assemblies, the respective load carrier is guided in a displaceable manner along the track.

In the specific embodiment, each load carrier has a vertically upward extending lance-shaped spindle, at the free end of which a receptacle for in each case one of the workpieces is arranged. In particular in the transition regions between the portions of the track that are inclined differently from one another, the free ends of the spindles, acting as cantilever arms, of two load carriers that are traveling directly one behind the other naturally move toward or away from one another. In order to prevent a collision of the workpieces placed on the spindles, the portions of the track can therefore include only slight inclines. Due to the tilting behavior, the load carriers must also maintain a suitable distance from one another. In other words, as a result of the required distance between the load carriers, inclined portions necessarily lead to the number of load carriers and thus also the number of possible workpieces per section unit being reduced, while the necessary lengths of the process zones are increased. In order to nevertheless obtain a sufficient capacity of the conveyor system, a speed increase of the load carriers along the track is required, which can have a negative effect on the achievable quality of the coating, in particular when vehicle wheels are to be coated.

A further possibility is the rotatable arrangement of two spindles per load carrier around a vertical axis. As a result, the two spindles of a load carrier can be arranged one behind the other in the direction of travel, while they are rotated by 90° before the start of an incline and can thus be arranged next to one another transversely to the direction of travel. As a result, the workpieces which are directly opposite and placed on two successive load carriers are spatially removed from one another so that a greater inclination of the spindles of the load carrier traveling ahead is permissible, which in turn enables greater inclination differences or inclines of the track.

In addition to the increased manufacturing costs and a more intensive maintenance of this embodiment, the rotatable arrangement of two spindles per load carrier requires more space laterally, at least in the region of the transitions between the portions, in order to prevent, for example, a collision between the received workpieces and other system parts. However, even without a rotatable design, the distance to be maintained between the individual load carriers reduces the performance of such a conveyor system since the number of workpieces that can be received necessarily decreases. Although power-and-free systems offer further possibilities here, they are, for example, relatively expensive to procure and operate in comparison to circulating conveyor systems. In view of these observations, existing conveyor systems still offer room for improvements.

### BRIEF SUMMARY OF THE INVENTION

The present invention is therefore based on the object of further developing a generic conveyor system in such a way that it enables a cost-effective and efficient way of transporting workpieces along a track having portions inclined differently from one another. Furthermore, an advantageous use of this conveyor system is to be provided.

This object is achieved by a conveyor system, in particular a circulating conveyor system, for the local transport of workpieces, comprising a track having rail sections extending next to one another, with portions which are inclined differently from one another in relation to a horizontal plane and along which load carriers designed to receive the workpieces are movable one behind the other, wherein each load carrier has a running gear with at least one first bearing assembly and at least one second bearing assembly, which is spaced apart from the first bearing assembly in relation to the extension of the track and through which the load carriers are guided on the track. Advantageous embodiments can be found in the dependent claims. One possible use of this conveyor system is with or in a coating system, wherein at least one section of the track of the conveyor system extends through the coating system and the workpieces to be transported through the coating system take the form of motor vehicle rims, in particular car rims, or comprise at least parts thereof.

For the conveyor system, the invention now proposes a differing relative height position, at least in some sections, between at least two rail sections running next to one another, in the portions of the track. Here, the load carriers are in each case guided via their first bearing assembly on at least one rail section and via their second bearing assembly on at least one further rail section running next to said rail section. The fact that the height position of at least two rail sections running next to one another, along the track varies at least in some sections has the effect that the load carriers supported thereon are oriented the same relative to the horizontal plane at every point on the track in relation to their direction of travel. In other words, each load carrier is supported, for example, via its front region on one of the rail sections, while, for example, its rear region is supported on the other rail section running next to said rail section. By changing the height position of the rail sections running next to one another, the orientation of the load carriers moving thereon necessarily also changes. By means of a corresponding relative height profile of the rail sections extending next to one another, it is therefore possible for the load carriers to always keep the same, in particular vertically upright, orientation at every position along the track.

The resulting advantage is that no elaborate embodiments and/or, for example, rotatable spindles of the load carriers are required in order to move the load carriers, arranged with the shortest possible distance between them, along the track. As a result of the constant orientation, relative to the horizontal plane, of the load carriers in their direction of travel, which is due to the design of the track, the load carriers no longer disadvantageously approach one another due to the otherwise usual inclination of the same, in particular in the transition regions between the differently inclined portions. Compared to the change in the height position of the bearing assemblies relative to one another, which otherwise takes place in the transition regions and in which the inclination change of the chord spanning between the bearing assemblies otherwise leads to the same extent to an inclination of the associated load carrier, the relative height position of the bearing assemblies now remains unchanged in an extremely advantageous manner. At the same time, the conveyor system can overall be produced and operated cost-effectively, wherein the possibility of the now significantly closer succession of the individual load carriers leads to an advantageous increase in performance in relation to the possible number of workpieces to be transported.

The conveyor system according to the invention permits a significantly improved layout, e.g., as a painting or coating system for vehicle wheels. Compared to the use of power-and-free systems, the conveyor system according to the invention enables a much simpler and thus more cost-effective structure in the form of a circulating conveyor system. The system structure and/or its system technology have/has an overall simplified and thus improved accessibility. Due to the inclination-free travel of the load carriers, the potential risk of the received workpieces slipping or even falling and also of their collision with one another now no longer exists. The structure of the conveyor system according to the invention requires only a few, in particular moving, elements, resulting in simplified maintenance and care, in addition to cost reduction, in particular in comparison to a power-and-free system.

In the context of the invention, a juxtaposition of the rail sections is not limited to a course of the same in parallel to the horizontal plane and thus laterally opposite but also comprises all other spatial positions of the rail sections relative to one another, such as one above the other or obliquely opposite one another.

According to a preferred development of the basic concept of the invention, the track can have a single outer rail section and a single inner rail section, on which sections the load carriers are guided via their bearing assemblies. Alternatively, the track can have not only two outer rail sections running at the same height position but also two inner rail sections running at the same height position, on which sections the load carriers are guided via their bearing assemblies. The latter embodiment can also be referred to as a double-rail section. As a result of the arrangement of two rail sections in each case at the same height position, an overall more stable guidance of the load carriers can be achieved. In principle, the respective rail sections can be arranged such that they are arranged either next to one another in relation to a horizontal or one above the other in relation to a vertical. Combinations thereof are likewise conceivable. By means of a correspondingly adapted design of the bearing assemblies, at least one of these bearing assemblies can, for example, be supported vertically on a rail section or between two rail sections. At least one of the bearing assemblies can, for example, also be supported horizontally on a rail section or between two rail sections.

Based on this, it is considered to be particularly advantageous if each of the load carriers is guided via its first bearing assembly on the inner rail sections, while the outer rail sections serve to guide the respective load carrier via its second bearing assembly. In this way, there is a clear assignment for each of the load carriers as to which of its bearing assemblies is guided along the track on the inner rail sections and which is guided on the outer rail sections.

With regard to the rail sections, various forms and cross-sections are conceivable. According to a particularly preferred embodiment, at least one of the rail sections can have a laterally open cross-section. This means that said rail section is effectively based on a hollow profile which can, for example, have two opposite side walls running perpendicularly to the horizontal plane, wherein just one of these side walls is absent or is continuously open at least in the longitudinal direction of the rail section. Advantageously, such a rail section can have a U-shaped or C-shaped cross-section. In principle, it is of course also conceivable to have single- or multiple-angled designs in the sense of an L-shaped or Z-shaped cross-section as well as combinations of the shapes mentioned. Here, it is possible to use standard profiles, which enables a cost-effective implementation.

Starting from a laterally open design of the rail sections in the sense of double-rail sections, it is considered to be advantageous if the inner rail sections face one another with their open sides, wherein they at least partially accommodate between them the first bearing assembly of each load carrier. This results in a stable guidance of the respective first bearing assembly of each load carrier on the inner rail sections with as little play as possible.

Furthermore, starting from a laterally open design of the rail sections, it is conceivable that the outer rail sections basically run continuously next to one another either with their open sides facing one another or with their open sides facing away from one another. This with respect to two outer rail sections integrating at least one inner rail section between them or outer double-rail section(s) arranged laterally of the at least one inner rail section.

Within the context of the invention, it is considered to be more advantageous for the orientation of the outer rail sections to one another to vary. The outer rail sections can thus face one another with their open sides in a portion of the track that rises relative to the horizontal plane. Alternatively or additionally, the outer rail sections can face away from one another with their open sides in a portion of the track that falls relative to the horizontal plane. In this way, it is possible for the guidance of the associated bearing assemblies on the outer rail sections to, for example, be carried out in a trailing manner in a portion (incline) that rises relative to the horizontal plane, while said guidance takes place in a leading manner in a portion (decline) that falls relative to the horizontal plane.

In a portion (flat) of the track that is parallel to the horizontal plane, the outer rail sections can face away from one another or face one another with their open sides.

In principle, the invention provides that the bearing assemblies of the individual load carriers in each case can have only one rolling body. Alternatively, the bearing assemblies can each have at least two rolling bodies. It is also possible, for example, that only the first bearing assembly has two rolling bodies, while the second bearing assembly has only one rolling body, and vice versa. The rolling bodies can advantageously be arranged next to one another in a transverse direction to the track. Alternatively or additionally, at least one of the rolling bodies can also be designed as a sliding body. A rolling body is understood to mean a body rolling with its circumference over a part of the rail sections and thus a rotatable body, while a sliding body has correspondingly low-friction properties at least in a region that comes or can come into contact with a part of the rail sections.

According to a preferred development of the conveyor system according to the invention, the respective second bearing assembly of the individual load carriers can have two support units with in each case only one, in particular inner or outer, rolling body or one inner rolling body and one outer rolling body.

The support units can advantageously be spaced apart from one another so that a stable support on the track results. In a portion (incline) of the track that rises relative to the horizontal plane, the load carriers can then be guided on the outer rail sections via the outer rolling bodies. Alternatively or additionally, in a portion (decline) of the track that falls relative to the horizontal plane, the load carriers can be guided on the outer rail sections via the inner rolling bodies.

In a flat portion (flat) running in parallel to the horizontal plane, the load carriers can be guided on the outer rail sections either via the outer rolling bodies or via the inner rolling bodies.

A change in the guidance of the load carriers via their inner rolling bodies or their outer rolling bodies can require a corresponding change in the orientation of the outer rail sections relative to one another. The outer rail sections can thus face one another with their open sides in order to guide the load carriers on the outer rail sections via their outer rolling bodies. In contrast, the outer rail sections can face away from one another with their open sides in order to guide the load carriers on the outer rail sections via their inner rolling bodies.

The conveyor system according to the invention now presented makes its extremely cost-effective structure and operation possible, wherein the absence of tilting of the load carriers due to the differently inclined portions of the track in the transition regions leads to an overall increased efficiency of the system.

The invention is furthermore aimed at a preferred use of the conveyor system according to the invention with or in a coating system. The coating system may be one for carrying out wet coatings and/or powder coatings. Furthermore, the coating system may also include such stations which serve for the pretreatment or aftertreatment of workpieces with respect to their coating. It is provided that at least one section of the track of the conveyor system extends through the coating system. Particularly preferably, the workpieces to be transported through the coating system can be motor vehicle rims, in particular car rims. At any rate, the workpieces can be parts of motor vehicle rims, as usual, for example, in multi-part designs of the same.

The advantages resulting from this have already been explained in more detail in connection with the conveyor system according to the invention so that, in order to avoid repetition, reference is made at this point to the corresponding contents in this regard.

### BRIEF DESCRIPTION OF THE DRAWINGS

The invention is explained in more detail below with reference to the exemplary embodiment illustrated in FIGS. 1 to 8. In the drawings:

FIG. 1 shows a detail of a conveyor system from the prior art in a schematic side view;

FIG. 2 shows a detail of a conveyor system according to the invention in a schematic side view;

FIG. 3 shows a detail of the conveyor system according to the invention in the region of an incline in a schematic side view;

FIG. 4 shows a detail of the conveyor system according to the invention in the region of a flat portion in a schematic side view;

FIG. 5 shows a detail of the conveyor system according to the invention in the region of a decline in a schematic side view;

FIG. 6 shows a load carrier of the conveyor system according to the invention of FIGS. 2 to 5 in a first front view;

FIG. 7 shows the load carrier of FIG. 6 in an alternative embodiment in a first front view; and

FIG. 8 shows the load carrier of FIG. 7 in a second front view.

### DETAILED DESCRIPTION OF PREFERRED EMBODIMENTS

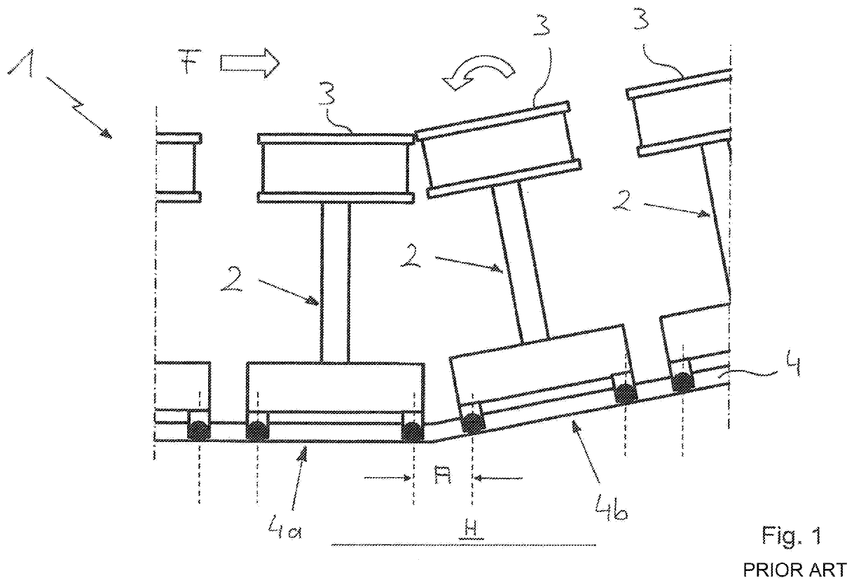

FIG. 1 firstly shows a conveyor system 1 from the prior art. The conveyor system 1 comprises a plurality of load carriers 2, each of which serves to receive a workpiece 3 that is to be transported. In the present case, the depictions of the individual workpieces 3 each show the side view of a motor vehicle rim, in particular a car rim, purely by way of example. Furthermore, the conveyor system 1 comprises a track 4 having successive portions 4a, 4b. The load carriers 2 are coupled to a drive (not shown in greater detail here), for example a circulating traction mechanism, via which they can be moved one behind the other along the track 4 in a direction of travel F. Without going into more detail at this point about the specific embodiment of the individual load carriers 2, FIG. 1 serves to illustrate their behavior in transition regions between two portions 4a, 4b of the track 4 that are inclined differently from one another in relation to a horizontal plane H. As can be seen, a first portion 4a runs in parallel to the horizontal plane H, while the subsequent second portion 4b is inclined relative to the first portion 4a and in this respect is also inclined relative to the horizontal plane H. Taking into account the direction of travel F, the second portion 4b represents an incline of the track 4. As soon as a load carrier 2 reaches the second portion 4b, it naturally tilts in proportion to the inclination thereof in the direction of the directly following load carrier 2 (indicated by a white curved arrow). In order to prevent a collision of the received workpieces 3 with one another in this case, the load carriers 2 must maintain a relatively large distance A from one another. In addition, the workpieces 3 must be appropriately secured in order to effectively prevent the associated load carrier 2 from slipping or even falling off.

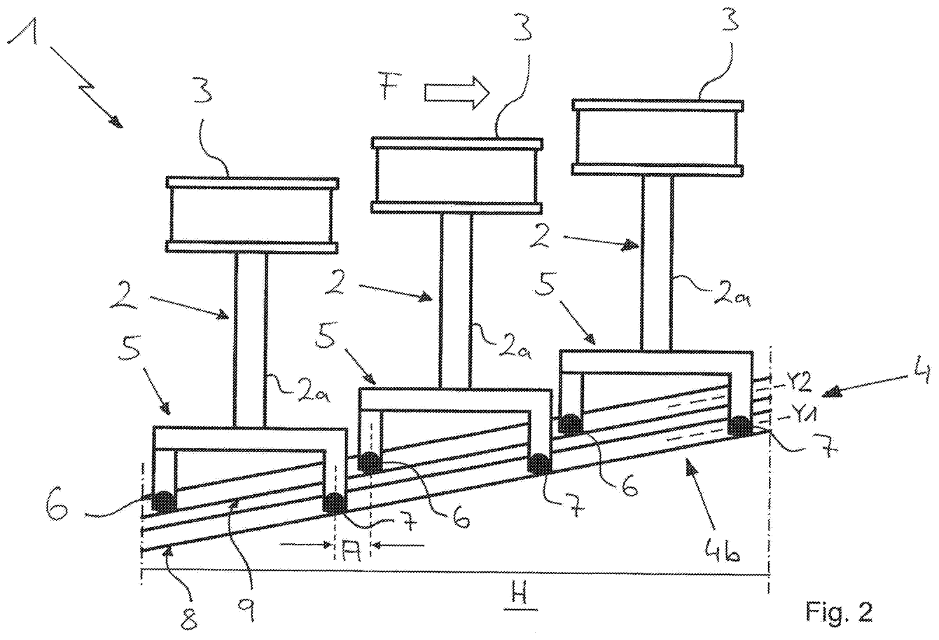

FIG. 2 shows a detail of a conveyor system 1 according to the invention in a side view. In relation to the direction of travel F, it is clear that the detail shows a portion 4b of the track 4 in the region of an incline. The individual load carriers 2 each have a running gear 5 which comprises a first bearing assembly 6 and a second bearing assembly 7. In relation to the extension of the track 4, the two bearing assemblies 6, 7 are clearly spaced apart from one another so that the individual load carriers 2 are guided in a stable manner along the track 4. In contrast, the track 4 comprises rail sections 8, 9 which extend next to one another and on which the individual load carriers 2 are movably supported via their bearing assemblies 6, 7. With regard to the workpieces 3 depicted here purely by way of example as motor vehicle rims, it is furthermore noteworthy that each load carrier 2 has a spindle 5a which extends perpendicularly to the horizontal plane H and on the free end of which receptacles (not shown in more detail) are arranged or formed for the workpieces 3.

Upon closer examination, it becomes clear that the rail sections 8, 9 of the track 4 run next to one another at different height positions Y1, Y2. In the present case, the first rail section 8 is located at a first height position Y1, which is below the height position Y2 of the second rail section 9, so that the second rail section 9 runs above the first rail section 8. Due to the different height positions Y1, Y2 of the individual rail sections 8, 9, each load carrier 2 as regards its spindle 2a is oriented in the present case perpendicularly to the horizontal plane H, although this is located on a portion 4b describing an incline. In other words, the different height positions Y1, Y2 of the individual rail sections 8, 9 of the track 4 here compensate for the bearing assemblies 6, 7, which are located opposite one another at the same height position, of the load carriers 2. In this way, the load carriers 2 do not undergo any tilting, so that they require a significantly smaller distance A from one another.

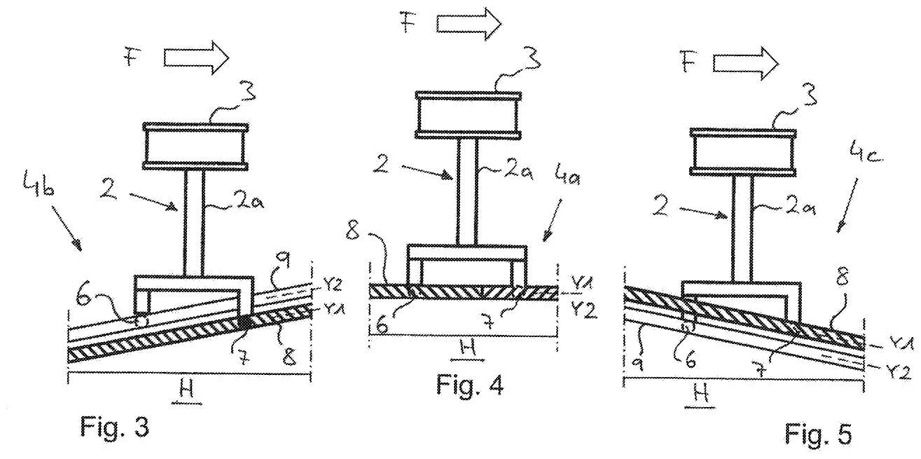

FIGS. 3 to 5 illustrate the changing height positions Y1, Y2 of the rail sections 8, 9 in the portions 4a to 4c of the track 4 that are inclined differently from one another, as explained in more detail below. In this context, it should first be noted that the individual rail sections 8, 9 are spaced apart from one another in relation to a transverse direction Y extending in parallel to the horizontal plane H and at the same time perpendicularly to the track 4. In other words, the rail sections 8, 9 are located in different planes in relation to the depth of the representations in the figures. For better clarification, the rail section 8, which is located in the foreground or further outward, is always shown hatched, while the rail section 9, which is located in the background or further inward, does not have such hatching; now in detail:

FIG. 3 again shows a portion 4b of the track 4 in the form of an incline, as can already be seen in FIG. 2. As can be seen, the bearing assembly 7 which leads in relation to the direction of travel F is guided on the outer rail section 8, while the bearing assembly 6 trailing in relation thereto is guided on the inner rail section 9.

FIG. 4 shows a portion 4a of the track 4 running in parallel to the horizontal plane H in the form of a flat portion. As can be seen, the inner rail section 9 is in this case concealed by the outer rail section 8. In other words, the two rail sections 8, 9 have the same height position Y1, Y2 in the flat portion so that the load carriers 2 continue to extend perpendicularly to the horizontal plane H as regards their spindles 2a.

FIG. 5 shows the situation in a decline of the track 4, in which the portion 4c is sloped downward in relation to the direction of travel F. As can be seen here, the height positions Y1, Y2 of the two rail sections 8, 9 have effectively changed relative to the incline in FIG. 3, so that the load carriers 2 also continue to extend perpendicularly to the horizontal plane H as regards their spindles 2a.

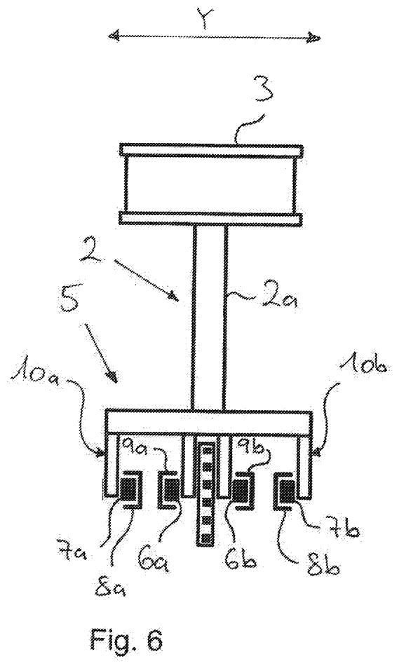

FIG. 6 shows a front view of a preferred embodiment of a load carrier 2 with a view opposite to the direction of travel F or in the longitudinal direction of the track 4. Only in this view does it become clear that the second bearing assembly 7 thereof has two support units 10a, 10b, which are spaced apart from one another in relation to a transverse direction Y and on which a rolling body 7a, 7b is rotatably arranged in each case. The position of the two individual rolling bodies 7a, 7b is shown here only purely by way of example. This means that the respective rolling body can be arranged either on a side of the associated support unit 10a, 10b facing the first bearing assembly 6 (as shown in FIG. 6) or on a side of the associated support unit 10a, 10b (not shown) facing away from the first bearing assembly 6. In the possible embodiment of the load carrier 2 shown, the first bearing assembly 6 comprises, as can be seen, two rotatable rolling bodies 6a, 6b located next to one another in the transverse direction Y.

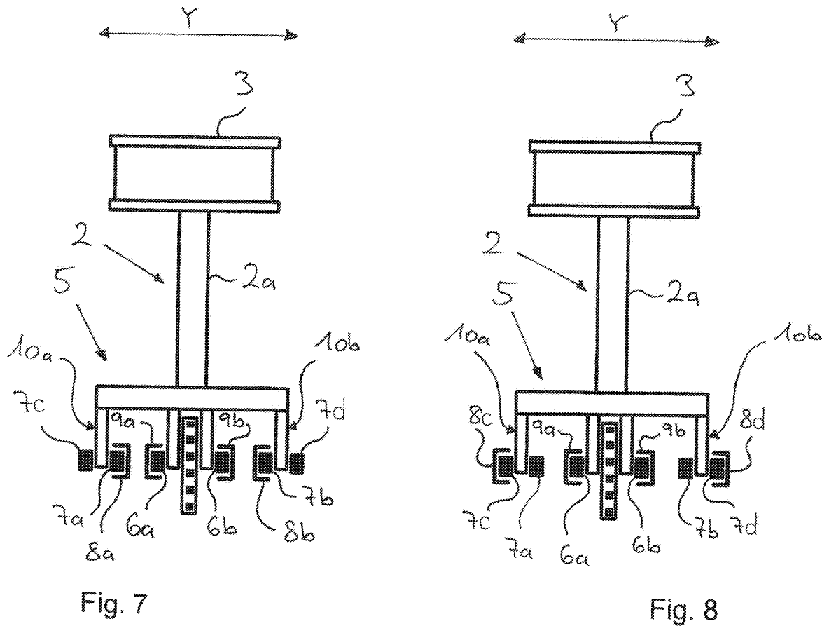

FIG. 7 is an alternative embodiment of the load carrier 2 in a front view of the latter as already shown in FIG. 6. In contrast to the embodiment in FIG. 6, the second bearing assembly 7 now comprises a total of four rolling bodies 7a to 7d, which are divided into two outer rolling bodies 7c, 7d facing away from one another and two inner rolling bodies 7a, 7b facing one another. Alternatively, only one inner rolling body 7b per support unit 10a, 10b can preferably be provided, while the outer rolling bodies 7a are omitted (not shown in detail). In this variant too, the first bearing assembly 6 comprises, purely by way of example, a total of two rotatable rolling bodies 6a, 6b located next to one another in the transverse direction Y.

The rail sections 8, 9, which have a laterally open, in particular C- or U-shaped, cross-section, are designed in duplicate so that the track 4 has two outer rail sections 8a, 8b running at the same height position Y1 and two inner rail sections 9a, 9b running at the same height position Y2, on which the load carriers 2 are guided via their bearing assemblies 6, 7. As can be seen, the two inner rail sections 9a, 9b face one another with their open sides such that between them, they at least partially receive the first bearing assembly 6 comprising two rolling bodies 6a, 6b. Here, in each case one of the two rolling bodies 6a, 6b rolls on the web of the associated inner rail section 9a, 9b, wherein the rolling bodies 6a, 6b are each restricted laterally by the flanges of the inner rail sections 9a, 9b against a displacement in relation to the transverse direction Y.

The position of the outer rail sections 8a, 8b can vary along the track 4 in such a way that in relation to their longitudinal direction, they run in each case rotated by 180° in the portions 4b having an incline and/or in the portions 4c having a decline (see FIG. 8). The corresponding changes can be carried out in the portions 4a having a horizontal flat portion, as indicated by way of example in FIG. 4 by the outer rail sections 8 having different hatchings. The embodiment of the track 4 shown in FIG. 6 can, for example, illustrate the situation in the region of a portion 4c of the track 4 (decline) that falls relative to the horizontal plane H and in which the open sides of the outer rail sections 8a, 8b face away from one another. As a result, the load carriers 2 are guided on the two outer rail sections 8a, 8b via the inner rolling bodies 7b of the second bearing assembly 7.

In relation to the alternative embodiment mentioned above, FIG. 8 is the situation then possible in the region of a portion 4b of the track 4 which rises relative to the horizontal plane H (incline), in which the open sides of the outer rail sections now rotated by 180° about their respective longitudinal axis face one another in the form of two outer rail sections 8c, 8d. In this way, the load carriers 2 can be guided in an incline via the outer rolling bodies 7c, 7d on the outer rail sections 8c, 8d oriented in this way. As already explained in more detail in connection with the first bearing assembly 6, the rolling bodies 7a to 7d of the second bearing assembly 7 always roll on a flange of the associated outer rail sections 8a to 8d.

With regard to the alternative embodiment shown in FIGS. 7 and 8, the change in the orientation of the outer rail sections 8a, 8b; 8c, 8d can take place in the portion(s) 4a (flat) of the track 4 parallel to the horizontal plane H, so that they can then face away from one another or face one another at least in some sections in that region. In the specific implementation, this can be effected in each case by two successive outer rail sections 8a, 8b; 8c, 8d, which have different orientations of their open sides. A continuous guidance of the rolling bodies 7a, 7b; 7c, 7d of the second bearing assembly 7 is ensured by means of a preferably overlap of their free ends at least in some sections.

### LIST OF REFERENCE NUMERALS

1 Conveyor system
2 Load carrier of 1
2a Spindle of 2
3 Workpiece
4 Track
4a Portion of 4 (flat)
4b Portion of 4 (incline)
4c Portion of 4 (decline)
5 Running gear of 2
6 First bearing assembly of 5
6a Rolling body of 6
6b Rolling body of 6
7 Second bearing assembly of 5
7a Inner rolling body of 7 on 10a
7b Inner rolling body of 7 on 10b
7c Outer rolling body of 7 on 10a
7d Outer rolling body of 7 on 10b
8 First rail section of 4
8a Outer rail section of 8
8b Outer rail section of 8
8c Outer rail section of 8
8d Outer rail section of 8
9 Second rail section of 4
9a Inner rail section of 9
9b Inner rail section of 9
10a Support unit of 7
10b Support unit of 7
A Distance
F Direction of travel of 2
H Horizontal plane
Y Transverse direction
Y1 Height position of 8 or 8a and 8b
Y2 Height position of 9 or 9a and 9b

1. A conveyor system (1), in particular a circulating conveyor system, for the local transport of workpieces (3), comprising a track (4) having rail sections (8, 9) extending next to one another, with portions (4a-4c) which are inclined differently from one another in relation to a horizontal plane (H) and along which load carriers (2) designed to receive the workpieces (3) are movable one behind the other, wherein each load carrier (2) has a running gear (5) with at least one first bearing assembly (6) and at least one second bearing assembly (7), which is spaced apart from the first bearing assembly (6) in relation to the extension of the track (4) and through which the load carriers (2) are guided on the track (4),
comprising relative height positions (Y1, Y2) that differ from one another at least in some sections, of at least two rail sections (8, 9) running next to one another, in the portions (4a-4c) of the track (4) in such a way that the load carriers (2), which are each guided via their first bearing assembly (6) on at least one rail section (9) and via their second bearing assembly (7) on at least one further rail section (8) running next to said rail section (9), are oriented the same relative to the horizontal plane (H) at every point of the track (4) in relation to their direction of travel (F).

2. The conveyor system (1) according to claim 1,
wherein the track (4) has only one outer rail section (8a, 8b) or two outer rail sections (8a, 8b) running at the same height position (Y1, Y2) and only one inner rail section (9a, 9b) or two inner rail sections (9a, 9b) running at the same height position (Y1, Y2), on which the load carriers (2) are guided via their bearing assemblies (6, 7).

3. The conveyor system (1) according to claim 2,
wherein each load carrier (2) is guided via its first bearing assembly (6) on at least one inner rail section (9a, 9b) and via its second bearing assembly (7) on at least one outer rail section (8a, 8b).

4. The conveyor system (1) according to claim 1,
wherein at least one of the rail sections (8, 9) has an angled or laterally open, in particular U-shaped or C-shaped, cross-section.

5. The conveyor system (1) according to claim 4,
wherein the inner rail sections (9a, 9b) facing one another with their open sides at least partially receive between them the first bearing assembly (6).

6. The conveyor system (1) according to claim 4,
wherein, in a portion (4b) of the track (4) that rises relative to the horizontal plane (H), the outer rail sections (8a, 8b; 8c, 8d) face one another with their open sides, and/or in a portion (4c) of the track (4) that falls relative to the horizontal plane (H), they face away from one another with their open sides.

7. The conveyor system (1) according to claim 4,
wherein, in a portion (4a) of the track (4) that is parallel to the horizontal plane (H), the outer rail sections (8a, 8b; 8c, 8d) face away from one another or face one another with their open sides.

8. The conveyor system (1) according to claim 1,
wherein the bearing assemblies (6, 7) in each case have only one rolling body (6a, 6b; 7a, 7b) or in each case have at least two rolling bodies (6a, 6b; 7a, 7c; 7b, 7d) arranged next to one another or one above the other in particular in a transverse direction (Y) in relation to the track (4).

9. The conveyor system (1) according to claim 6,
wherein the second bearing assembly (7) of the load carriers (2) has two support units (10a, 10b), each having an inner rolling body (7a, 7b) and/or an outer rolling body (7c, 7d), wherein in a portion (4b) of the track (4) which rises relative to the horizontal plane (H), the load carriers (2) are guided via the outer rolling bodies (7c, 7d) on the outer rail sections (8c, 8d), and/or in a portion (4c) of the track (4) which falls relative to the horizontal plane (H), they are guided via the inner rolling bodies (7a, 7b) on the outer rail sections (8a, 8b).

10. A method for using a conveyor system (1) with or in a coating system, wherein at least one section of a track (4) of the conveyor system (1) extends through the coating system and the workpieces (3) to be transported through the coating system take the form of motor vehicle rims, in particular car rims, or comprise at least parts thereof,
wherein the track (4) has rail sections (8, 9) extending next to one another, with portions (4a-4c) which are inclined differently from one another in relation to a horizontal plane (H) and along which load carriers (2) designed to receive the workpieces (3) are movable one behind the other, wherein each load carrier (2) has a running gear (5) with at least one first bearing assembly (6) and at least one second bearing assembly (7), which is spaced apart from the first bearing assembly (6) in relation to the extension of the track (4) and through which the load carriers (2) are guided on the track (4),
wherein relative height positions (Y1, Y2) that differ from one another at least in some sections, of at least two rail sections (8, 9) running next to one another, in the portions (4a-4c) of the track (4) in such a way that the load carriers (2), which are each guided via their first bearing assembly (6) on at least one rail section (9) and via their second bearing assembly (7) on at least one further rail section (8) running next to said rail section (9), are oriented the same relative to the horizontal plane (H) at every point of the track (4) in relation to their direction of travel (F).
